(19) United States
(12) Patent Application Publication
(10) Pub. No.: US 2010/0111278 A1
(43) Pub. Date: May 6, 2010

(54) Telecommunication Systems

(75) Inventors: Georg Trimborn, Skokie, IL (US); Richard Piper, McKinney, TX (US); Michael Kelly, Omaha, NE (US); Steve Upton, Snoqualmie, WA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/262,485

(22) Filed: Oct. 31, 2008

(51) Int. Cl. H04M 3/42

(52) U.S. Cl. 379/201.12

(57) ABSTRACT

According to an embodiment of the invention, there is provided a method of controlling access to services of a communication network at an access point through which access devices access services through the network, comprising: obtaining from a subscriber database details of services which a subscriber using an access device is entitled to access; receiving a request from the access device to use a service and, in response thereto, granting access to the requested service based on the obtained details.

### BACKGROUND

Conventional telecommunication systems, such as telephony systems, employ billing systems through which subscribers or users of the telephony system are billed for their charge-incurring use made of the telephony system. Generally, network operators offer a choice of post-pay or pre-pay billing plans which are provided by an appropriate billing system.

In post-pay systems, charge-incurring calls made through the telephony system by a subscriber are collated by the billing system over a fixed period, such as a month, and the subscriber is invoiced for all charge-incurring use made since the previous invoice was issued. In this way the subscriber pays for charge-incurring use made of the telephony system after the use has occurred. One of the main problems for network operators with post-pay systems, however, is the risk of non-payment of invoices.

In pre-paid systems, a subscriber maintains a credit in subscriber account of the billing system, and before any charge-incurring use may be made of the telephony system the balance of the subscriber account is checked. Charge-incurring use may typically only be made whilst the subscriber has a positive account balance. In this way the subscriber pays in advance prior to any charge-incurring use of the telephony system occurring. In pre-paid systems the subscriber account balance is generally updated in substantially real-time so that the account balance held in the billing system accurately accounts for all charge-incurring use made of the telephony system by the subscriber. If ever the account balance reaches zero the user is typically prevented from making any further charge-incurring use of the telephony system.

In both post-pay and pre-pay systems substantial numbers of messages are sent to and from the billing system by different elements in the telephony system. For example, in a pre-pay system, messages may be sent to and/or from the billing system: when a call is made to verify whether the subscriber has enough credit to make the call; prior to the call to confirm that the subscriber is allowed to make the call; during the call to periodically ensure that the subscriber has sufficient credit to continue the call; and when the call ends to ensure that the cost of the call is correctly accounted. In post-pay systems, messages may be sent to and/or from the billing system: prior to each call to verify whether the subscriber is entitled to make the call; and after every call to indicate the length of the call made and the called number.

Evidently, the processing of these messages requires processing resources, such as suitably configured computer hardware and software. As the number of subscribers increases, so does the amount of computer hardware and software required to process these messages.

### SUMMARY

According to one aspect of the present invention, there is provided a method of controlling access to services of a communication network. The access control is performed at an access point through which access devices access services through the network. The method comprises obtaining, from a subscriber database, details of services which a subscriber using an access device is entitled to access. The method further comprises receiving a request from the access device to use a service and, in response thereto, granting access to the requested service based on the obtained details.

According to a second aspect of the present invention there is provided a system for controlling access to services of a communication network. The system comprises a subscriber database that includes details of subscribers and services entitled to be accessed by those subscribers. The system further comprises a network access point through which access devices connect to access services through the network. The network access point is arranged for obtaining, from the database, details of the services to which a subscriber using an access device is entitled to access. The network access point grants access to the access device, in response to receiving a request from an access device to access a service, based on the obtained details.

According to a third aspect of the present invention, there is provided a computer readable medium, having embodied thereon computer readable code which, when executed, performs a method of controlling access to services of a communication network at an access point through which access devices access services through the network, comprising: obtaining from a subscriber database details of services which a subscriber using an access device is entitled to access; receiving a request from the access device to use a service and, in response thereto, granting access to the requested service based on the obtained details.

### BRIEF DESCRIPTION

Embodiments of the invention will now be described, by way of non-limiting example only, with reference to the accompanying drawings, in which:

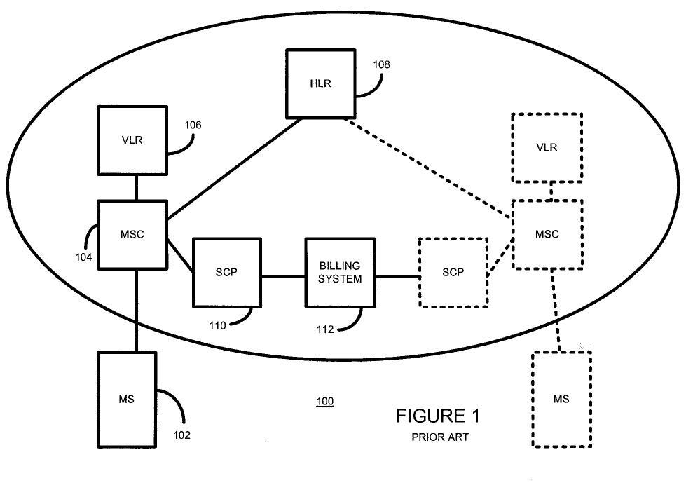

FIG. 1 is a block diagram showing a simplified overview of part of a mobile telephony network according to the prior art;

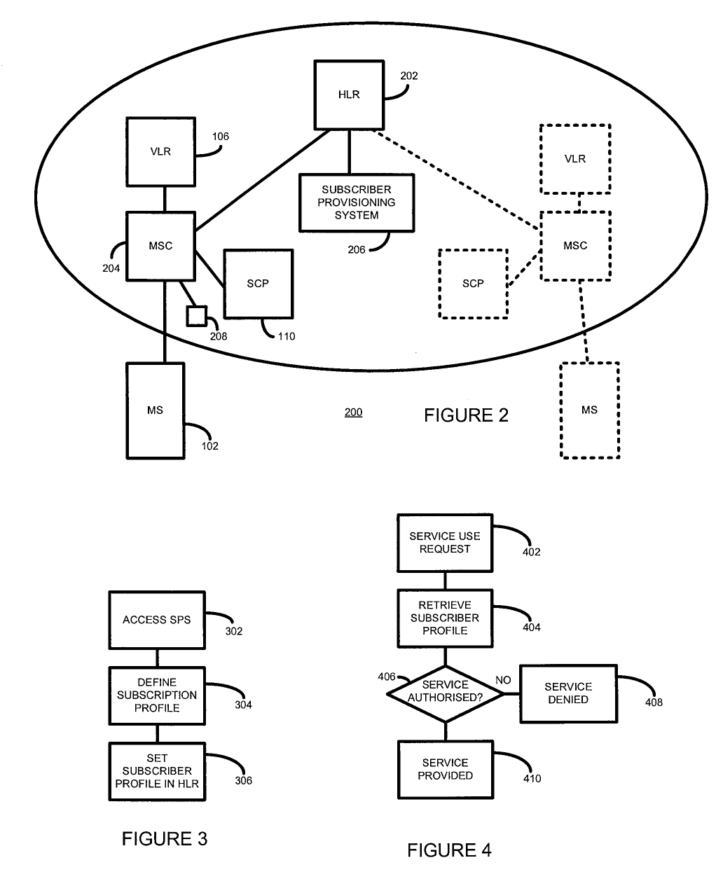

FIG. 2 is a block diagram showing a simplified overview of a mobile telephone network 200 according to an embodiment of the present invention;

FIG. 3 is a simplified flow diagram outlining example processing steps taken according to an embodiment of the present invention;

FIG. 4 is a simplified flow diagram outlining example processing steps taken according to an embodiment of the present invention;

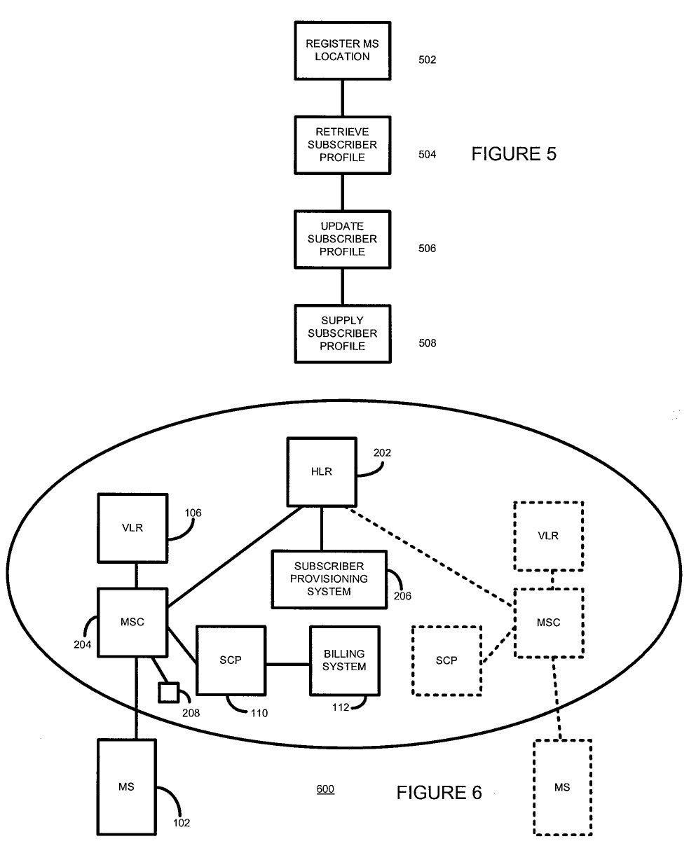

FIG. 5 is a simplified flow diagram outlining example processing steps taken according to an embodiment of the present invention;

FIG. 6 is a block diagram showing a simplified overview of a mobile telephone network 600 according to a further embodiment of the present invention; and

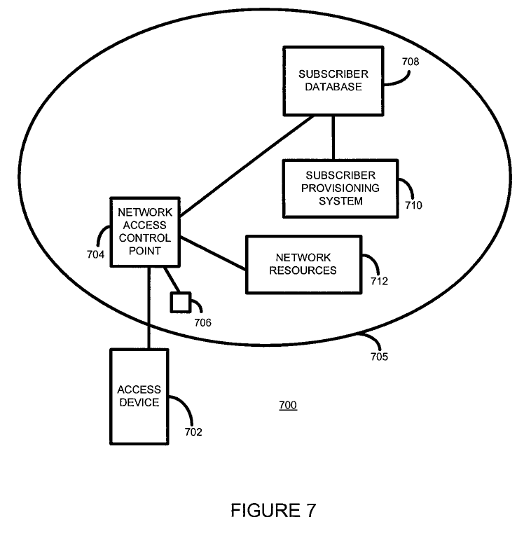

FIG. 7 is a simplified block diagram showing a network access control system according to a yet further embodiment.

### DETAILED DESCRIPTION

Referring now to FIG. 1, there is shown a simplified overview of a mobile telephony network 100 according to the prior art. Those skilled in the art will appreciate that for clarity, not all elements of the mobile telephony network are shown.

A mobile station 102, such as a conventional mobile telephone, wirelessly connects to a mobile switching centre (MSC) 104, through a base station and base station controller (not shown) in a known manner, for example using the GSM mobile telephony system. When the mobile station 102 initially connects to the MSC 104 the MSC contacts the home location register (HLR) 108 for the network 100. The MSC 104 updates the HLR 108 with the current location of the mobile station 102 to enable calls made to the mobile station 102 to be routed appropriately. The MSC 104 also stores the identity of the current base station to which the mobile station 102 is connected in the VLR 106.

When the mobile station 102 makes a call, a call establishment request is sent from the mobile station 102 to the MSC 104. If the subscriber associated with the mobile station 102 is a pre-pay customer the MSC 104 recognizes this and requests authorization from a service control point (SCP) 110 to connect the call. The SCP 110 in turn requests authorization from the billing system 112 to connect the call. If the subscriber has sufficient credit in their account the billing system 112 authorizes the SCP 110 to connect the call for a predetermined amount of time, and the MSC 104 connects the call. Shortly before the authorized amount of time expires the SCP 110 requests authorization from the billing system 112 to continue the call for another predetermined amount of time. This sequence continues until either the subscriber runs out of credit or until the call is terminated.

All of the above-described interactions require multiple messages to be sent between different network elements of the network 100, not only during the call setup, but also for the duration of the call and upon termination of the call.

FIG. 2 shows a block diagram showing a simplified overview of a mobile telephony network 200 according to an embodiment of the present invention. Common elements between FIG. 1 and 2 are shown by way of like reference numerals.

The telephony network 200 according to the present embodiment is able to do away with the conventional billing system 112 by using a HLR 202 and an MSC 204, along with a subscriber provisioning system (SPS) 206, as will be described below in further detail with additional reference to FIGS. 3, 4, 5 and 6.

Prior to making any calls the subscriber provisioning system (SPS) 206 is used to set a subscriber profile in the HLR 202 defining a ‘class of service’ for a subscriber. A class of service, as used herein, defines the types of services provided by the mobile telephony network 200 that the subscriber is entitled to use. For example, typical services may include: making local calls, making national calls, making international calls, roaming, making video calls, using data services, sending short message system (SMS) messages, sending multimedia message system (MMS) messages, and the like.

The SPS 206 may be accessible (step 302), for example via a web-interface over the Internet, for the subscriber to subscribe to (and pay for) one or more classes of service (step 304). The SPS 206 may, additionally, or alternatively, be used by the network operator of the network 200 to provision services to subscribers after having received suitable payment. In addition to defining the actual services subscribed to, the subscriber profile additionally includes a time expiry field. The time expiry field may denote a time and date at which all of the subscribed services expire, or may alternatively be associated with a specific one or more of the subscribed services.

For example, a subscriber may pay a flat fee to make unlimited local calls, unlimited national calls, and to send unlimited SMS messages during a given time period. The time period may be any suitable time period such as, for example, a year, a month, a week, a day, an hour, etc.

When the subscriber profile has been defined it is set (step 306) in the HLR 202.

When a mobile station, such as the mobile station 102, initially wishes to connect to an MSC, such as the MSC 204, it sends a registration request message to the MSC. The MSC 204 receives the registration request message and registers (step 502) the current location of the mobile station 202 with the HLR 202. This enables calls made to the mobile station 102 to be routed appropriately.

As part of the registration steps, the HLR 202 retrieves (step 504) the subscriber profile of the subscriber associated with the MS 102. The HLR 202 dynamically checks any time expiry fields associated with any classes of services and updates (step 506) the subscriber profile accordingly. For example, if the time expiry field of an ‘international calls’ class of service has expired, the HLR 202 removes that class of service from the subscriber profile. The subscriber profile is then supplied (step 508) to the MSC 204 which stores it in a subscriber profile store 208.

The MSC 204 regularly registers the location of the MS 102 with the HLR 202, for example, as part of a periodic registration step, or whenever the MS 102 connects to a different MSC. In this way, the subscriber profile stored in the subscriber profile store 208 is updated regularly.

When the mobile station 102 requests (step 402) to make use of a service provided by the network 200, a service use request is sent to the MSC 204. For example, if the mobile station 102 makes a national call, a call establishment message identifying the called number is sent to the MSC 204. The MSC 204 determines the class of service requested, in this case a national call, and retrieves (step 404) the subscriber profile for the appropriate subscriber from the subscriber profile store 208. If the subscriber profile indicates (step 406) that national calls are allowed, the MSC 204 connects the call (step 410). At the end of the call the call is terminated in the normal manner.

In contrast to prior art systems using a billing system, no billing related messages are sent either prior to the call being setup, during call setup, during the call, or after the call has terminated. Advantageously, this may reduce significantly the number of messages sent and received by the MSC 204 and SCP 110, leading to potential important reductions in the processing resources required thereby.

If the requested service is not enabled for the subscriber (step 406) access to the service is denied (step 408). In this case, the subscriber may be connected to a suitable interface, such as an interactive voice response unit (IVR), call centre operator, web page, etc, where the subscriber can be informed, for example, of the reason why the service request was denied. The subscriber may also be given the opportunity to purchase rights to the service, for example by being suitably connected to the SPS 206.

In an alternative embodiment, the subscriber profile supplied to the MSC 204 from the HLR 202 may include the time expiry fields for each class of service. In this way, the MSC 204 can check the time expiry field of a class of service whenever a request to use that class of service is made by a mobile station.

In a further embodiment the MSC 204 does not store a local copy of the subscriber profile, but requests or obtains the subscriber profile directly from the HLR whenever a service use request is received from a mobile station at the MSC 204. In this way, whenever a service use request is received the subscriber profile is dynamically updated by the HLR 202 to take into account any time expiry flags, ensuring that the MSC 204 has an update-to-date subscriber profile prior to determining whether a subscriber is entitled to use a service.

In a telecommunication network 300 according to a yet further embodiment, shown in FIG. 6, a conventional billing system, such as the billing system 112, is included in addition to the HLR service class approach described above. In this way, if a service use request is denied (step 408), the service use request may be forwarded to the billing system 112 (either a pre-pay or post-pay billing system) for billing in a more conventional manner. It may be preferable to inform the subscriber, for example through a voice message, that a particular service is going to be billed through a conventional billing system prior to the service being provided.

A yet further embodiment is illustrated in FIG. 7. FIG. 7 shows a generic network access control system 700. An access device 702, such as an electronic personal digital assistant, portable or desktop computer, or the like connects to a network access control point 704 of a network 705. The network 705 comprises a subscriber database containing details of all subscribers of the network 705.

Prior to the access device 702 connecting to the network 705, a subscriber provisioning system (SPS) 710 is used to set a subscriber profile in the subscriber database 708 defining a ‘class of service’ for that subscriber. A class of service, as used herein, defines the types of services provided by the network 705 that the subscriber is entitled to use. For example, typical services may include: making voice over IP (VoIP calls), browsing the Internet, downloading content, sending emails, etc.

As described above, with reference to the SPS 206, the SPS 710 may be accessible via a web-interface over the Internet for the subscriber to subscribe to (and pay for) one or more classes of service. The SPS 710 may, additionally, or alternatively, be used by the network operator of the network 705 to provision services to subscribers after having received suitable payment. In addition to defining the actual services subscribed to, the subscriber profile additionally includes a time expiry field. The time expiry field may denote a time and date at which all of the subscribed services expire, or may alternatively be associated with a specific one or more of the subscribed services. When the subscriber profile has been defined it is set in the subscriber database 708.

When the access device 702 initially connects to the network access control point 704, the access device 702 sends a message to the control point 704 requesting to register itself thereon. In response to this registration request, the network access control point 704 obtains from the subscriber database 708 the current subscriber profile for the subscriber associated with the access device 702 and stores this in a local subscriber database 706. Prior to providing the subscriber profile the subscriber database 706 updates the subscriber profile according to any time expiry fields associated with any classes of service.

Subsequently, when the access device 702 requests to make use of a service provided by the network 705, a request is sent to the network access control point 704. The network access control point 704 determines the class of service requested and retrieves the subscriber profile for the appropriate subscriber from the subscriber profile store 706. If the subscriber profile indicates that the requested service is allowed, the network access control point 704 enables access to the relevant network resources 712.

If the requested service is not enabled for the subscriber access to the service is denied. In this case, the subscriber may be connected to the subscriber provisioning system 710 where the subscriber may be given the opportunity to purchase rights to the service.

Those skilled in the art will appreciate that the above-described embodiments are non-limiting in nature. For example, further embodiments may be adapted for use with IMS (IP multi-media sub-system) systems having a HSS (home subscriber server).

Embodiments within the scope of the present invention also include computer-readable media for having computer-executable instructions or data structures stored thereon and also known as computer software. Such computer-readable media can be any suitable media accessible by a general purpose or special purpose computer. Computer-executable instructions may comprise, for example, instructions and data which cause a general purpose computer, special purpose computer, or special purpose processing device to perform a certain function or group of functions.

The software of the present invention can be implemented in several different ways. The implementation of the software is not limiting on the invention. In one embodiment, the software is installed on a computer readable medium as computer readable code which, when executed, carries out the functionality of the present invention as described herein. In another embodiment, the software is pre-loaded and installed as part of an operating system kernel.

1. A method of controlling access to services of a communication network at an access point through which access devices access services through the network, comprising:
obtaining from a subscriber database details of services which a subscriber using an access device is entitled to access;
receiving a request from the access device to use a service and, in response thereto,
granting access to the requested service based on the obtained details.

2. The method of claim 1, wherein the step of obtaining is arranged for one of:
obtaining in response to receiving a request to connect an access device to the access point; and obtaining in response to receiving a request from the access device to use a service.

3. The method of claim 1, wherein the subscriber database comprises details of a plurality of services a subscriber is entitled to access and a time expiry indicator indicating a time and date when the subscriber is no longer entitled to access each service, the step of obtaining from the subscriber database further comprising obtaining details of services for which the time expiry indicator has not expired.

4. The method of claim 1, further comprising, where access to a requested service is not granted, forwarding the request from the access device to use the service to a network-based billing system.

5. The method of claim 1, further comprising, where access to a requested service is not granted, connecting the user device to a service provisioning system.

6. The method of claim 1, further comprising provisioning details of services which a subscriber is entitled to access for a predetermine duration in response to receiving payment from the subscriber, such that use made of an entitled service made during the predetermined period does not require any interaction with a billing system.

7. The method of claim 1, adapted for use in a telephony network.

8. The method of claim 7, adapted for use wherein the access point is a mobile switching center, wherein the subscriber database is one of either a home location register or a home subscriber server, and wherein the access device is a mobile telephone.

9. A system for controlling access to services of a communication network comprising:
a subscriber database including details of subscribers and services entitled to be accessed by those subscribers; and
a network access point through which access devices connect to access services through the network;
the network access point being arranged for obtaining, from the database, details of the services to which a subscriber using an access device is entitled to access;
the network access point being further arranged for granting the access device, in response to receiving a request from an access device to access a service, access to a service based on the obtained details.

10. The system of claim 9, wherein the network access point is arranged for obtaining the details either in response to receiving a request from the access device to connect to the access point, or in response to receiving a request from the access device to access a service.

11. The system of claim 9, wherein the subscriber database includes details of a plurality of services a subscriber is entitled to access and a time expiry indicator indicating a time and date when the subscriber is no longer entitled to access each service, the subscriber database being arranged for providing details of services for which the time expiry indicator has not expired.

12. The system of claim 9, further comprising a service provisioning system for provisioning in the database details of services which a subscriber is entitled to access for a predetermined duration in response to receiving payment from the subscriber.

13. The system of claim 12, the system being further adapted for forwarding non-granted access requests to the service provisioning system.

14. The system of claim 9, further comprising a billing system, the system being adapted for forwarding non-granted access requests to the billing system.

15. The system of claim 1, wherein the access point is mobile switching system, the subscriber database is one of a home location register or a home subscriber server, and wherein the access device is mobile telephone.

16. A computer readable medium, having embodied thereon computer readable code which, when executed, performs a method of controlling access to services of a communication network at an access point through which access devices access services through the network, comprising:
obtaining from a subscriber database details of services which a subscriber using an access device is entitled to access;
receiving a request from the access device to use a service and, in response thereto,
granting access to the requested service based on the obtained details.
